(19) United States
(12) Patent Application Publication
(10) Pub. No.: US 2006/0118586 A1
(43) Pub. Date: Jun. 8, 2006

(54) Vehicular cargo carrier with adaptable multi-platforms

(76) Inventor: Ramin Heravi, Aliso Viejo, CA (US)

Correspondence Address: RAMIN HERAVI, 19 DESTINY WAY, ALISIO VIEJO, CA, 92656, US

(21) Appl. No.: 11/005,209

(22) Filed: Dec. 4, 2004

(51) Int. Cl. B60R 9/00

(52) U.S. Cl. 224/519; 224/521; 224/42.32; 224/558; 224/564

(57) ABSTRACT

It is an object of the present invention to provide a single cargo carrier that utilizes an extended hitch frame with removable carrier platforms that can optionally provide multi-platforms at different level as needed to be used for transferring different objects and provide easy transfer of goods. Such objects can be a wagon, toolbox, bicycles, ski racks, luggage, wheelchair, etc. This cargo carrier generally comprises an extended hitch frame, a first carrier platform and a second carrier platform. The first and second carrier platforms are removably mounted on the lower and upper level of the base member of the extended hitch frame. For those objects that need to be transported frequently, the carrier platform may be permanently attached to the bottom of transferring objects for propose of easy loading and unloading onto the extended hitch frame.

### FIELD OF THE INVENTION

The present invention relates to a cargo carrier attachable to towing frame of vehicle. More particularly, the invention relates to a cargo carrier that can adapt to a variety of carrier platforms for transporting goods such as wagons, bicycles, storage containers, wheelchair, etc.

### BACKGROUND OF THE INVENTION

Often it is desirable to transport a bulky and odd sized object at the same time via a single cargo carrier. Some objects are required to be placed at different level than other objects due to their heights and required space to be placed on. Some prior patents refer to such problems. For example, U.S. Pat. No. 6,006,973, issued to Belinkly et al, disclosed “A bike rack cargo carrier for mounting to a vehicle hitch allowing bicycles to be transported outside the vehicle. The bike carrier includes a drawbar adapted to be received within the vehicle hitch and a cargo platform adjustably attached to platform relative to the rear of the vehicle.”

Another U.S. Pat. No. 5,950,891, issued to Brungardt et al, disclosed “A bicycle rack adapted to be detachably mounted to a vehicle via a standard trailer hitch receiver with the bicycle rack having a vertical support pivotally connected at its lower end to a base assembly with a bicycle carrier assembly connected to the upper end of the vertical support.”

In spite of the advantages of these devices in prior art, there are some limitations that can not be delivered for the purpose of easy transfer of different type of objects with respect to their sizes, weights, and heights. Especially those objects that often need to be transferred frequently and loading/unloading can be cumbersome. For example carrying a wagon and a motorcycle at the same time requires two separate cargo carriers or carrying bicycles along with a wheelchair requires a bike rack carrier and a cargo carrier to transfer such items.

However, this invention overcomes the shortcomings of conventional devices and provides a single cargo carrier that utilizes an extended hitch frame with removable carrier platforms that can optionally provide multi-platforms at different level as needed to be used for transferring different objects and provide easy transfer of goods.

### SUMMARY OF THE INVENTION

It is an object of the present invention to provide a single cargo carrier attachable to towing frame of vehicle that can transport different objects due to its sizes, weights, and heights at different level above the ground. Such objects can be a wagon, toolbox, bicycles, ski racks, luggage, wheelchair, and so on. This cargo carrier generally comprises an extended hitch frame, a first carrier platform and a second carrier platform. The extended hitch frame which can be tubular in cross section includes a horizontal lower base member, a vertical support member and a horizontal upper base member. The first and second carrier platforms are removably mounted onto horizontal lower or upper base members of extended hitch frame. The carrier platforms are positioned in different level depends upon the type of load and height of the transferring goods. These carrier platforms generally constructed using a tubular collar with an attached top platform to place and hold objects. Furthermore, the carrier platform's collar may also be a collar with three sides and it is shaped like an inverted “U” for easy mounting onto expanded hitch frame which is normally a rectangular tubular in cross section.

It is another object of this invention to mount carrier platforms on the bottom of a transporting object permanently. Such platforms can be mounted on the bottom portion of a wagon or on the bottom of a toolbox for means of carrying and loading onto extended hitch frame for easy loading and unloading purposes. This type of platform may be mounted to the bottom of transporting object in arrangement of two or more to secure the transporting goods. The arrangement can be in a row.

It is yet another object of present invention to provide exchangeable carrier platforms to be used at different level of extended hitch frame as needed to transport objects.

Further objects and advantages of this invention will become apparent from consideration of the drawings and description that follows.

### BRIEF DESCRIPTION OF THE DRAWINGS

Exemplary embodiments of the invention will now be described in conjunction with the drawings in which:

FIG. 1 is a perspective view of the present invention showing assembled cargo carrier at two different level of transporting but the wagon and vehicle towing frame are spaced away for clarity of drawing.

FIG. 2 is a side view of assembled cargo carrier shown in FIG. 1.

FIG. 3 is an exploded view of cargo carrier shown in FIG. 1-2.

FIG. 4 is a cross sectional view taken along line 4-4 in FIG. 2.

FIG. 4A is a cross sectional view similar to FIG. 4, but showing only the mounted carrier platform by itself.

FIG. 5 is a cross sectional view similar to FIG. 4, showing alternative embodiment of the carrier platform.

FIG. 5A is a cross sectional view similar to FIG. 5, showing only the mounted carrier platform by itself.

FIG. 6 is an exploded view of cargo carrier with exchangeable carrier platforms.

FIG. 7 is an exploded view of cargo carrier with bike rack carrier platforms.

FIG. 7A is a partial assembled perspective view of bike rack carrier platform.

FIG. 8 is an exploded view of an alternative of a cargo carrier showing the extended hitch frame with two horizontal upper base members.

### DETAILED DESCRIPTION OF THE INVENTION

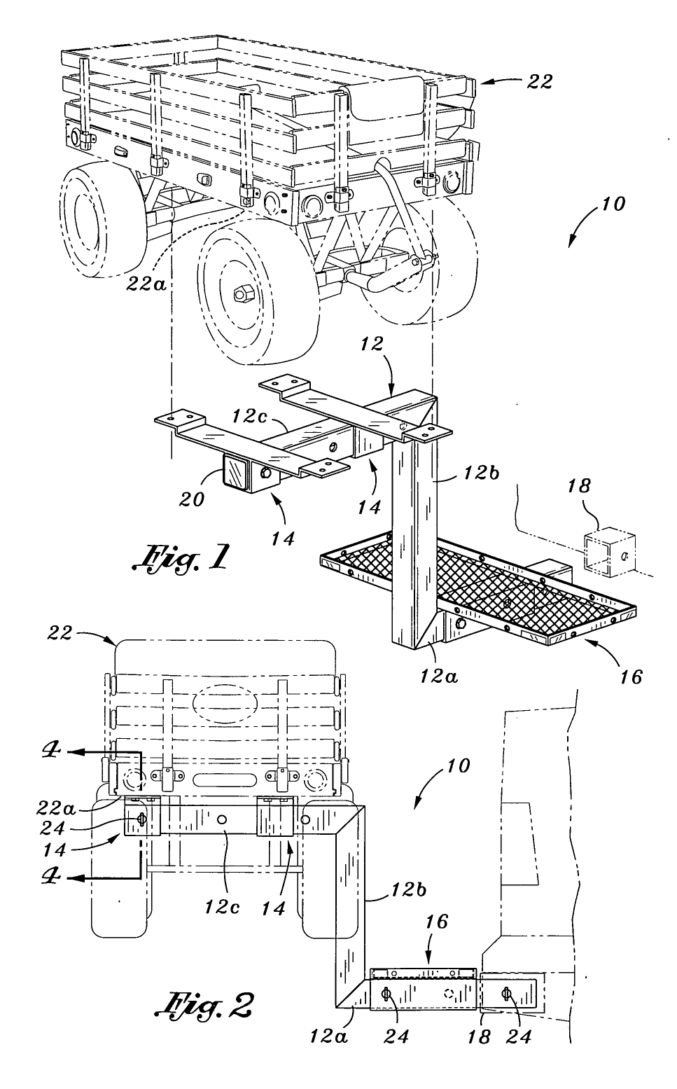

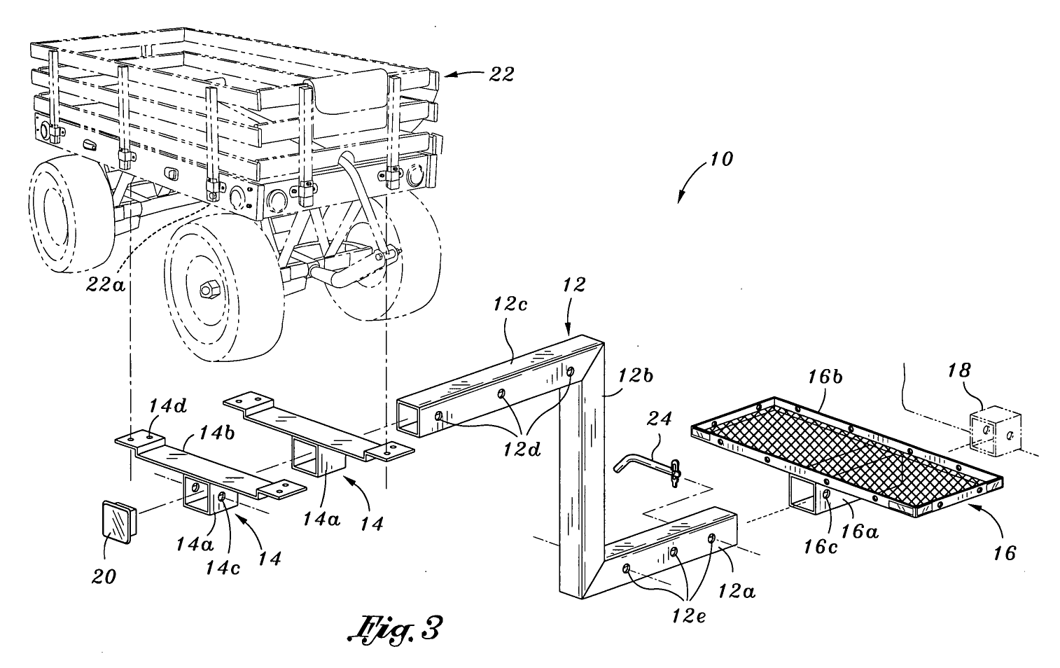

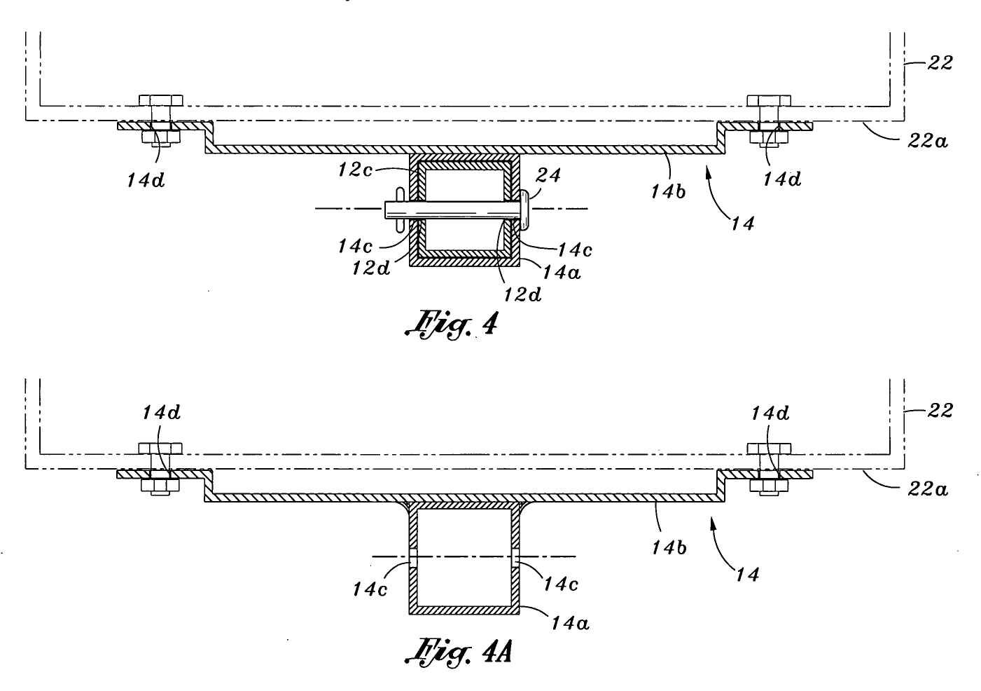

FIG. 1 is a perspective view of the present invention showing assembled single cargo carrier for transporting goods using two different levels of carrier platforms. The cargo carrier 10 generally comprises an extended hitch frame 12, a first carrier platform 14 and a second carrier platform 16. The extended hitch frame 12 includes a horizontal lower base member 12a which removably mounted onto a vehicular towing frame at one end through a locking pin 24, a vertical support member 12b is jointed at its lower end at 45 degree cut to other end of the horizontal lower base frame 12a, and a horizontal upper base member 12c is jointed at one end at 45 degree cut to the upper end of the vertical support member 12b. As it is shown in FIG. 2-3, the first carrier platform 16 is removably mounted onto lower base member 12a of extended hitch frame 12 for means of transporting goods such as wheelchair, tool boxes, containers, etc. The second carrier platform 14 is removably mounted on the extended hitch frame 12 at the upper base member 12c for means of transporting goods such as a wagon, bikes, ski racks, etc. Each carrier platforms has a mounting collar 14a, 16a that can be removably mounted onto the hitch frame 12 via pluralities of holes, and having a top platform 14b, 16b which hold objects for transferring purposes. Optionally, the top platform 14b, 16b can be used as a mounting bracket 14b for transporting object that are frequently loaded and unloaded.

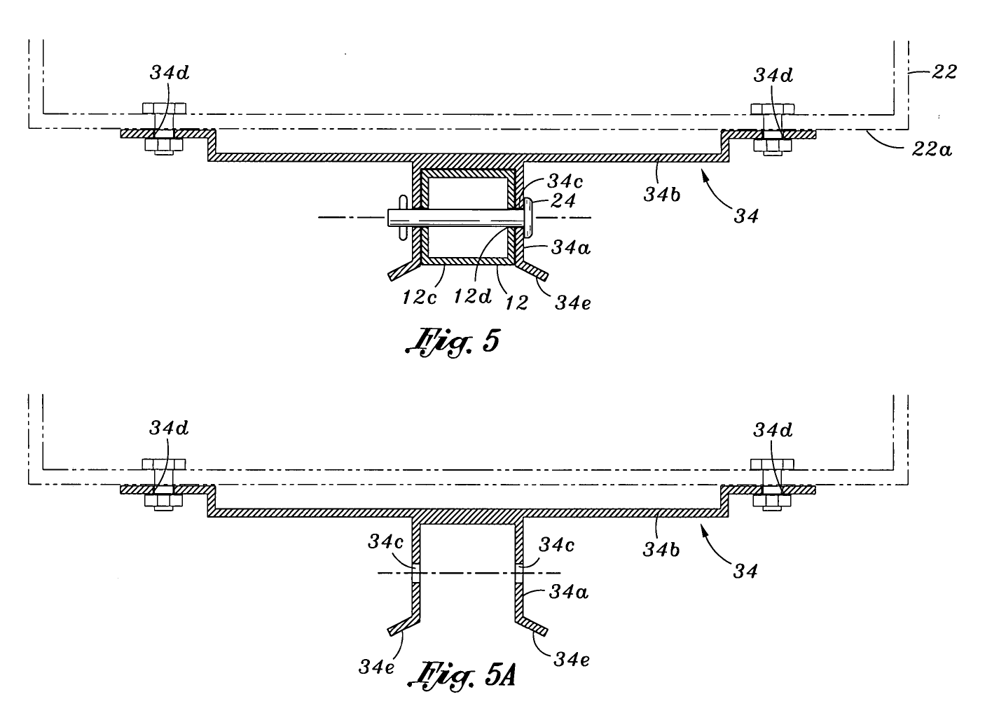

FIG. 1-4a, illustrate the second carrier platform 14 has a mounting top bracket 14b that is mounted underneath the bottom 22a of transferring object that frequently being transport such as a wagon 22. Once it is mounted underneath the wagon 22 the mounting collar 14a of the carrier platform 14 is placed onto the upper base member 12c of hitch frame 12 and secures it with a locking pin 24. One of advantages of this design is for the loading and unloading of the objects without using any other type of devices to secure the objects while transporting and quickly installs onto the towing hitch frame.

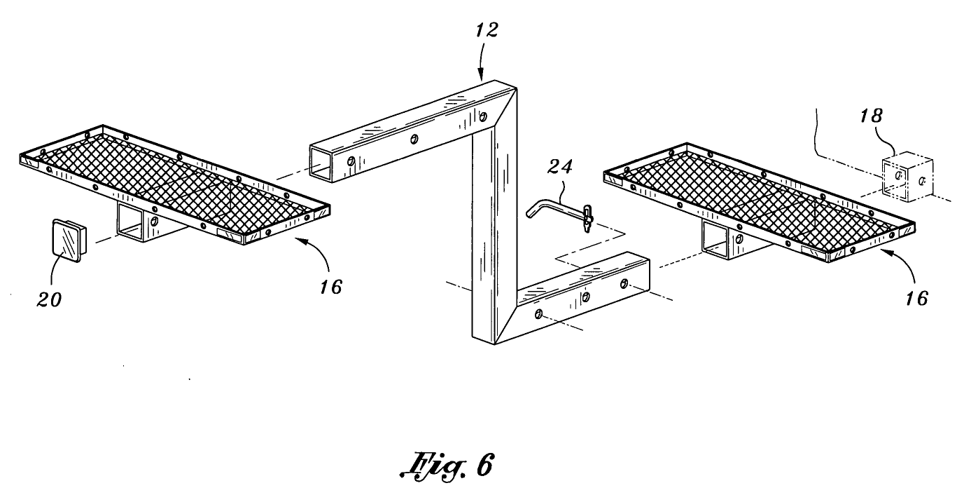

Preferably, the mounting collar 34 of carrier platform 14 may have three sides that can be placed over the extended hitch frame 12 as illustrated in FIG. 5-5A. This collar is shaped like an inverted “U” and has pluralities of mounting holes 34c on its two sides for mounting purposes. The bended portions of the edges of the sides 34e are for easy locating of hitch frame base. These outward bends usually are at 30 degree chamfer. Although, the carrier platforms are made of two separate parts and welded together, it is possible to make it into a unitary part using extrusion manufacturing process.

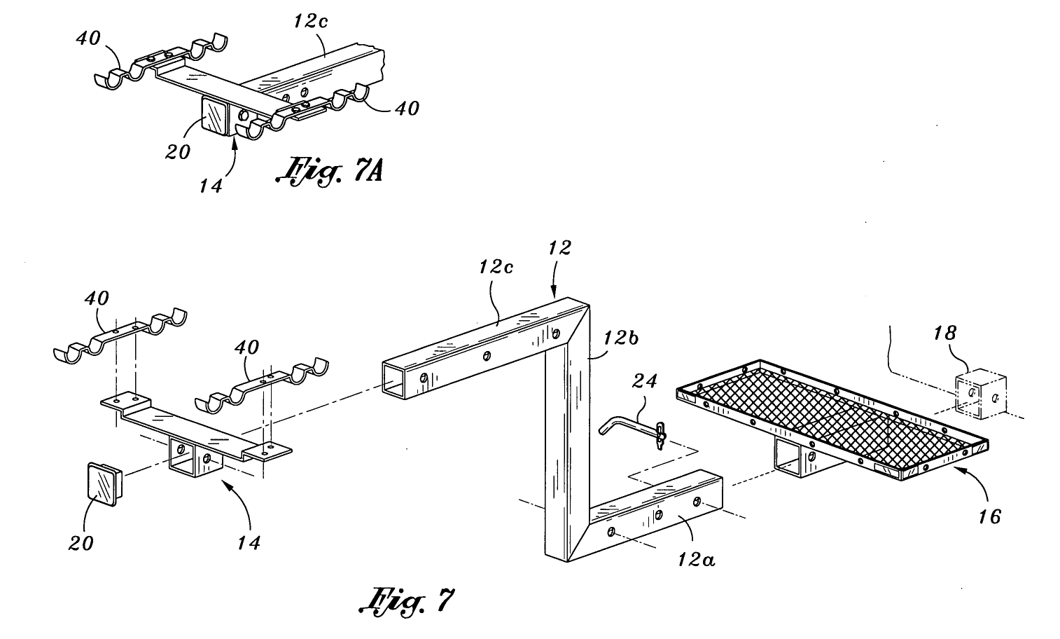

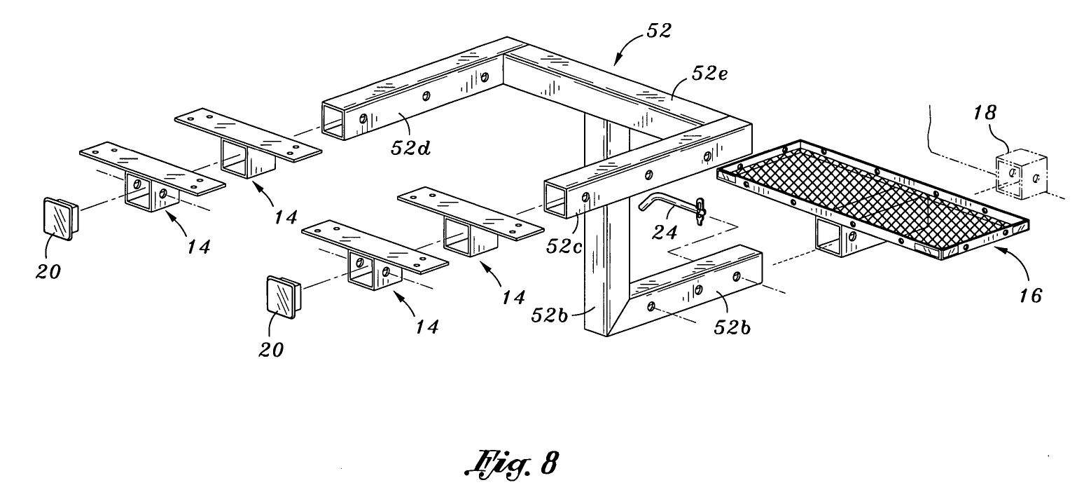

Referring to FIG. 6, showing two similar carrier platforms 16 are placed onto the extended hitch frame 12 via the lower and upper base members. In this design the two types of carrier platforms 16 are exchangeable and can be used on two different levels for carrying goods. Another advantage of this design is to replace a carrier platform with another type of carrier platform for different use based upon the type of loads. As illustrated in FIG. 7-7A, a set of bike racks 40 is added to carrier platform 14. These bike racks 40 can hold and transport up to four bicycles (not shown). Additional carrier platforms 14 also may be added to the upper base member 12c as needed to carry more bicycles. The bike racks can be mounted on the top platform or bracket or can be welded permanently. A locking cover (not shown) can also be added to the bike rake bracket to secure the bicycles in place while transporting. A reflective end cap 20 is placed at the end of the upper base member of hitch frame 12 for safety purpose as well.

FIG. 8 showing an alternate embodiment of the extended hitch frame 52. In this embodiment the upper horizontal base member configured into two upper base members 52d, 52c via a cross bar 52e welded over the vertical support member 52b. This configuration allows placing wider objects as it needs to be transported.

While this invention is susceptible of embodiments in many different forms, this specification and the accompanying drawings disclose only some specific forms as examples of the invention. The invention is not intended to be limited to the embodiments so described, however, the scope of the invention is pointed out in the appended claims.

I claim:

1. A vehicular cargo carrier with adaptable multi- platforms comprising:
an extended hitch frame, said hitch frame includes a horizontal lower base member which is removably mounted onto a vehicular towing frame at one end, a vertical support member is jointed at its lower end to other end of said horizontal lower base frame, and a horizontal upper base member is jointed at one end to the upper end of said vertical support member;
a first carrier platform, said first carrier platform is removably mounted on said extended hitch frame at said lower base member for means of transporting goods; and,
a second carrier platform, said second carrier platform is removably mounted on said extended hitch frame at said upper base member for means of transporting goods.

2. A vehicular cargo carrier with adaptable multi-platforms according to claim 1, wherein said extended hitch frame is tubular in cross section.

3. A vehicular cargo carrier with adaptable multi-platforms according to claim 1, wherein said extended hitch frame have a reflective end cap at the end of said horizontal upper base member.

4. A vehicular cargo carrier with adaptable multi-platforms according to claim 1, wherein said extended hitch frame has pluralities of holes for means of mounting of said first carrier platform and second carrier platform onto said extended hitch frame.

5. A vehicular cargo carrier with adaptable multi-platforms according to claim 1, wherein said a first carrier platform includes a mounting collar and a top platform attached to said mounting collar for means of holding goods.

6. A vehicular cargo carrier with adaptable multi-platforms according to claim 1, wherein said a second carrier platform includes a mounting collar and a top platform attached to said mounting collar for means of holding goods.

7. A vehicular cargo carrier with adaptable multi-platforms according to claim 5 & 6, wherein said a top platform, can be a tray.

8. A vehicular cargo carrier with adaptable multi-platforms according to claim 5 & 6, wherein said a top platform, can be a mounting bracket.

9. A vehicular cargo carrier with adaptable multi-platforms according to claim 8, wherein said a mounting bracket, can be mounted to a wagon.

10. A vehicular cargo carrier with adaptable multi-platforms according to claim 5 & 6, wherein said a top platform, can be attached to a set of bike rack brackets.

11. A vehicular cargo carrier with adaptable multi-platforms according to claim 5 & 6, wherein said a mounting collar, alternatively can be a collar with three sides.

12. A vehicular cargo carrier with adaptable multi-platforms comprising:
an extended hitch frame, said hitch frame includes a horizontal lower base member which is removably mounted onto a vehicular towing frame at one end, a vertical support member is jointed at its lower end to other end of said horizontal lower base frame, and a horizontal upper base member is jointed at one end to the upper end of said vertical support member;
first carrier platforms, said first carrier platforms are removably mounted on said extended hitch frame at said lower base member for means of transporting goods; and,
a second carrier platform, said second carrier platform is removably mourited on said extended hitch frame at said upper base member for means of transporting goods.

13. A vehicular cargo carrier with adaptable multi-platforms according to claim 12, wherein said first carrier platforms can be more than two platforms arranged in a row.

14. A vehicular cargo carrier with adaptable multi- platforms comprising:
an extended hitch frame, said hitch frame includes a horizontal lower base member which is removably mounted onto a vehicular towing frame at one end, a vertical support member is jointed at its lower end to other end of said horizontal lower base frame, two horizontal upper base members are jointed at their ends to a cross bar which is attached to the upper end of said vertical support member;
first carrier platforms, said first carrier platforms are removably mounted on said extended hitch frame at said lower base member for means of transporting goods; and,
a set of carrier platform, said carrier platform is removably mounted on said extended hitch frame at said upper base members for means of transporting goods.
